(19) United States
(12) Patent Application Publication
(10) Pub. No.: US 2007/0033288 A1
(43) Pub. Date: Feb. 8, 2007

(54) Method of using pause time information on media content in UPnP environment

(75) Inventors: Bong-yen Kim, Seongnam-si (KR); Jung-yon Cho, Suwon-si (KR); Young-chul Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/484,765

(22) Filed: Jul. 12, 2006

(30) Foreign Application Priority Data
Aug. 8, 2005 (KR) 10-2005-0072399

(51) Int. Cl. G06F 15/16

(52) U.S. Cl. 709/230

(57) ABSTRACT

A method and apparatus of using pause time information on media content under an UPnP environment. A method of using pause time information on media content under UPnP environment includes: transmitting the media content to a first media renderer; receiving a signal that stops the media content from being transmitted; stopping transmitting the media content and adding the pause time information on the media content to the media content or metadata that stores information on the media content; and transmitting the media content from a pause point of time if the first media renderer or a second media renderer requests transmission of the media content

This application claims priority from Korean Patent Application No. 10-2005-0072399 filed on Aug. 8, 2005, in the Korean Intellectual Property Office, the disclosure of which is incorporated herein by reference in its entirety.

### BACKGROUND OF THE INVENTION

1. Field of the Invention

The present invention relates to a home network, and more particularly, to a method of using pause time information on media content in a UPnP environment.

2. Description of the Related Art

As demands for home personal computers “PCs” increase and various multi-media content is provided through the Internet and data sharing, a home network market, which involves, for example, connections between home multi-media terminals and PCs, has been drawing attention. A home network involves two or more apparatuses in a home communicating with one another. The currently-used home network includes a data network, in which various peripheral devices are connected to a PC in order to share data through the Internet, and an audio visual “AV” network for multi-media data transmissions among AV products including a video player, a TV, and others.

In order to construct the home network, home appliances are required to be connected to one another in a wired or wireless manner, and middleware is needed to control and inter-connect the home appliances. The wired technique may be realized by a telephone line, a power line, an ethernet, an IEEE1394 connection, a USB, or others, and the wireless technique may be realized by a wireless LAN that conforms to the IEEE 802.11x series, HomeRF, Bluetooth, UltraWideBand “UWB”, Zigbee, a HiperLAN, or others. In addition, the home appliances may be connected by Universal Plug and Play “UPnP”, HAV (Home Audio Video interoperability), Jini, or others.

UPnP is a de facto industrial standard defined by a UPnP forum composed of a number of companies. In particular, UPnP is an architecture which generally will be used to connect the home PC with other intelligent apparatuses or appliances through a peer-to-peer network. Since the UPnP is a technique based on Internet standards such as TCP/IP, HTTP, and XML, these apparatuses and appliances can be automatically connected to one another and shared by many people through networking (especially, home networking).

A UPnP network includes a control point “CP” that controls a device and a number of devices that provide a service. Specifically, the control point provides a user interface and the user inputs an order to the control point through the user interface, and thus it is possible to discover and describe various devices and control the various devices. In addition, by constructing a network in which an Internet Protocol “IP” is used between the control point and the devices, it is possible to unify the data network, the AV network, and control a home network with the support of the IP even if the data network, the AV network, and the control network use different physical media.

In the current UPnP device architecture version 1.0, common internet protocols such as TCP/IP and the HTTP, an eXtensible Markup Language “XML”, and a Simple Object Access Protocol “SOAP” are used.

A stacked structure of a protocol for the UPnP network includes: a network layer using the IP; a transport layer using UDP and TCP; a presentation/session layer using protocols such as HTTP, protocols such as the XML, the SOAP, and the Simple Service Discovery Protocol “SSDP”, and a technique such as a Generic Event Notification Architecture “GENA”; and an application layer having information related to a UPnP device, a forum, a company, or the like. In a UPnP network to which the UPnP protocol stack is applied, the communication between the control point and the devices is performed by the following six steps.

(1) An addressing step in which IP addresses are assigned for the devices;

(2) A discovery step in which the CP discovers the devices;

(3) A description step in which the CP obtains information on the devices and services provided by the devices;

(4) A control step in which the CP calls the services of the devices;

(5) An event step in which the devices inform the CP of a change of conditions of the devices; and

(6) A presentation step in which the devices share conditions and control information about themselves.

As such, by using functions described above, a user can realize a home network without complicated network-setting processes.

FIG. 1 illustrates a method of playing back media in the UPnP environment. A media server 10 is a server that stores media content. This content can be played back or used by a first media renderer 31. A user can watch specific content on a first media renderer 31 through the media server 10, and can watch the content again on a second media renderer 32.

The entire functional flow is outlined as follows. The control point 20 obtains the list of content (an XML document) that is under management of the media server 10. After selecting one content item, the control point 20 requests a first media renderer 31 to playback the content as a uniform resource identifier “URI”. Then, the first media renderer 31 sends an “http-get” to the media server 10 to find the content. At this time, if a user wants to watch the content, which is being played back on first media renderer 31 on the second media renderer 32, the control point 20 sends a browse order to media server 10 to find the corresponding content, and then requests the playback of the content on the second media renderer 32. In that case, if content pause time information (pause point during watching content on first media renderer 31), is transmitted to second media renderer 32, the intricacy to find out the pause time on a second media renderer 32 can be avoided.

### SUMMARY OF THE INVENTION

It is an aspect of the present invention to provide pause time information on media content to various apparatuses under the UPnP environment in order to overcome the above-mentioned problem.

It is another aspect of the present invention to use the content without pausing on a media renderer by using pause time information on content played back on many apparatuses.

The present invention is not limited to the aspects mentioned above. Other aspects of the present invention will become apparent by those skilled in the art through the following detailed description.

According to an aspect of the present invention, a method of using pause time information on media content under the UPnP environment includes: transmitting the media content to a first media renderer; receiving a signal that stops the media content from being transmitted; stopping transmitting the media content and adding the pause time information on the media content to the media content or metadata on the media content; and transmitting the media content from a pause point of time if the first media renderer or a second media renderer requests transmission of the media content.

According to another aspect of the present invention, a method of using pause time information on media content under the UPnP environment includes: playing back the media content; stopping playing back the media content; adding the pause time information on the media content to the media content or metadata on the media content; and playing back the media content from a pause point of time when the media content needs to be played back again.

### BRIEF DESCRIPTION OF THE DRAWINGS

The above and other features and aspects of the present invention will become more apparent by describing in detail the exemplary embodiments thereof with reference to the attached drawings in which:

FIG. 1 is a schematic diagram illustrating a method of playing back media content in related art under the UPnP environment;

FIG. 2 is a schematic diagram illustrating a case in which a content directory service “CDS” of a media server stores pause time information when playback of the content is stopped according to an exemplary embodiment of the present invention;

FIG. 3 is a schematic diagram illustrating a case in which a control point stores pause time information when playback of the content is stopped according to another exemplary embodiment of the present invention;

FIG. 4 is a diagram illustrating an XML document, which contains information on the content of the media server;

FIG. 5 is a diagram illustrating that the pause time information is created as an item to be stored equally with “res” according to this exemplary embodiment of the present invention;

FIG. 6 is a diagram illustrating that the pause time information is set as an attribute value within a “res” region according to another exemplary embodiment of the present invention;

FIG. 7 is a diagram illustrating that the pause time information is created as an item according to another exemplary embodiment of the present invention;

FIG. 8 is a flow chart illustrating processes of storing a period of time, in which the content is paused in the media server, in metadata according to this exemplary embodiment of the present invention; and

FIG. 9 is a flow chart illustrating processes in which a control point changes the pause time information, which is stored in the media server, by using UpdateObject according to an exemplary embodiment of the present invention.

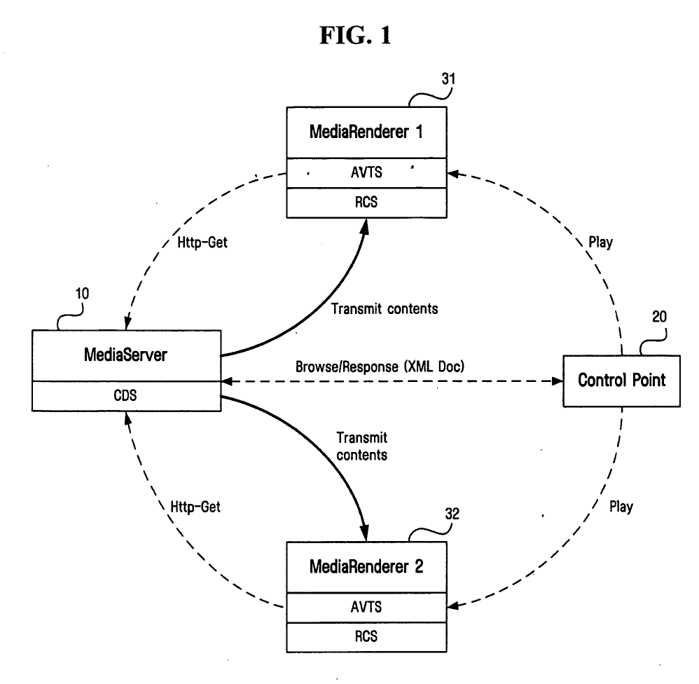

### DETAILED DESCRIPTION OF THE PREFERRED EMBODIMENTS

The aspects and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Hereinafter, the aspects and features of the present invention will become more apparent by describing in detail exemplary embodiments thereof with reference to the attached block diagrams or flow charts illustrating the method of the invention for using pause time information on media content in a UPnP environment. It will be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

Terms used in this description are defined as follows.

Control Point

A control point is a device serving as a mediator between a media server and a media renderer, and provides a function for controlling other apparatus in the UPnP. The control point borrows the list of content stored in the media server or under management of a server. If a user selects specific content from the list, the control point transmits the corresponding information on the content to the media renderer, and if a user inputs a media content related order, such as playback of the content, the control point sends an HTTP-GET to the media server based on information on the corresponding content.

Media Server

A media server provides information on content stored or under management in the form of an XML document, when a request such as browse is received from the control point. The information on content includes a title, a creator and a URI (URI of resource), and others. If the media renderer sends an HTTP-GET regarding content, the media server transmits the content corresponding to the URI. A CDS of the media server provides definitions of actions making the control point search and manage content of the media server. Actions are exemplified by browse, update, delete, and create. The control point can get information on content of the media server in XML form through browse.

Media Renderer

A media renderer renders media content. The media content rendering means showing or transmitting sound of content to a viewer according to properties of the media content. That is, the rendering means playing back the content. Presenting an image or a moving picture on a TV screen and playback of a music file, such as an MP3 file or a WAV file, in audio equipment, are examples of rendering. The media renderer is any kind of apparatus that provides the functions of showing or transmitting sound of the media content to a viewer; for example a TV, a DVD, or a CD player. The media renderer also provides services like AV Transport Service “AVTS” and rendering control service “RCS.” The AVTS provides definitions of actions enabling playback of the content saved in the media server by the control point. The rendering control service “RCS” provides definitions of actions of the control point for controlling the conditions of the media renderer such as brightness, contrast, and volume of the content being transmitted from the media server.

If the media content played back on the media renderer 1 needs to be played back on another media renderer 2, it is possible to pause the media content on the media renderer 1 and play back the content on the media renderer 2. At this time, if pause time information is stored together with media content related information, the media renderer 2 can play back the content from the pause time.

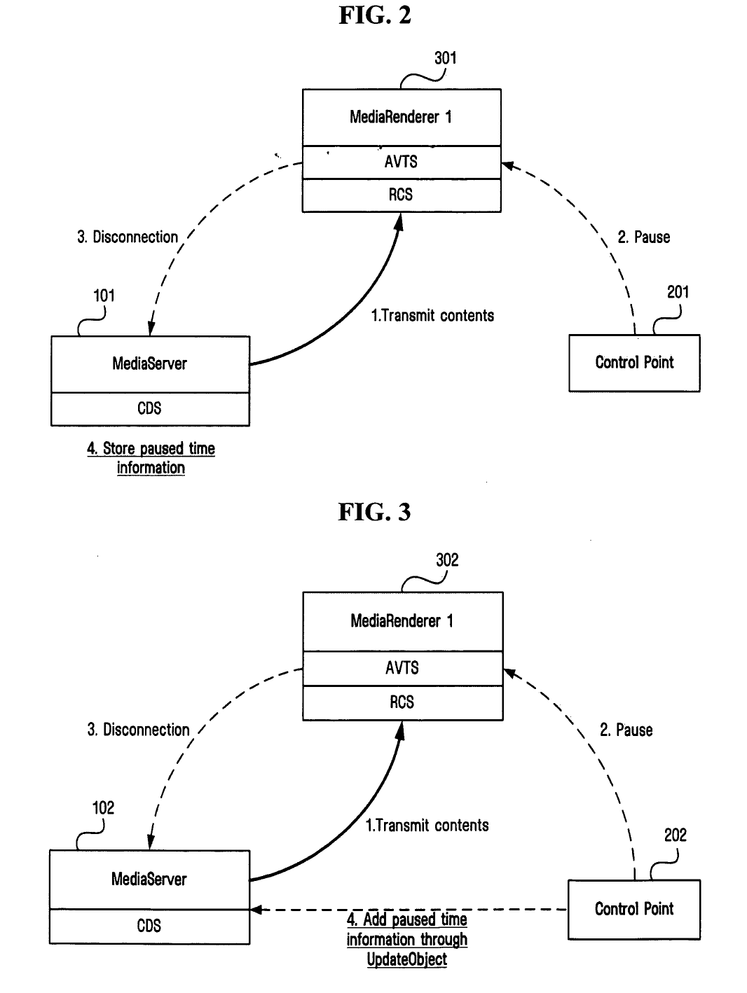

FIG. 2 is a schematic diagram illustrating a case, in which the CDS of the media server stores the pause time information when the playback of content is stopped, according to an exemplary embodiment of the present invention. A first media renderer 301 receives media content from a media server 101 and plays back the media content. At this time, a control point 201 requests the first media renderer 301 to pause the playback of the content. The first media renderer 301 terminates the connection with the media server 101. At this time, the media server 101 can record the pause time information on the content intervened. For example, if motion picture content having two hour playback time is paused 50 minutes after playback begins, the media server 101 records the information that the motion picture content has been played back for 50 minutes. In addition, the media server 101 stores the information on start time and pause time of the motion picture content. Then, the CDS of the media server 101 records the information on the content.

When the content is played back in the first media renderer 301 or in another media renderer in a different place later, a user decides whether he plays back the content from the beginning or from the pause point of time.

FIG. 3 is a schematic diagram illustrating a case, in which the control point stores the pause time information when the playback of content is stopped, according to another exemplary embodiment of the present invention. A first media renderer 302 carries out playback of the content received from a media server 102. At this time, a control point 202 requests the first media renderer 302 to pause the playback of the content. Then, the first media renderer 302 terminates the connection with the media server 101. At this time, the control point 202 stores pause time information in media server 102 without the aid of media renderer 302 through UpdateObject.

When the content are played back in the first media renderer 302 or in another media renderer in different place later, a user decides whether he plays back the content from the beginning or from a pause point of time.

In FIGS. 2 and 3, the methods of storing the pause time information on media content have been described according to the exemplary embodiments of the present invention. It is also important to decide how to store the information.

The media server provides information on content on the basis of an XML document. Accordingly, the pause time information on media content can also be stored in the XML document.

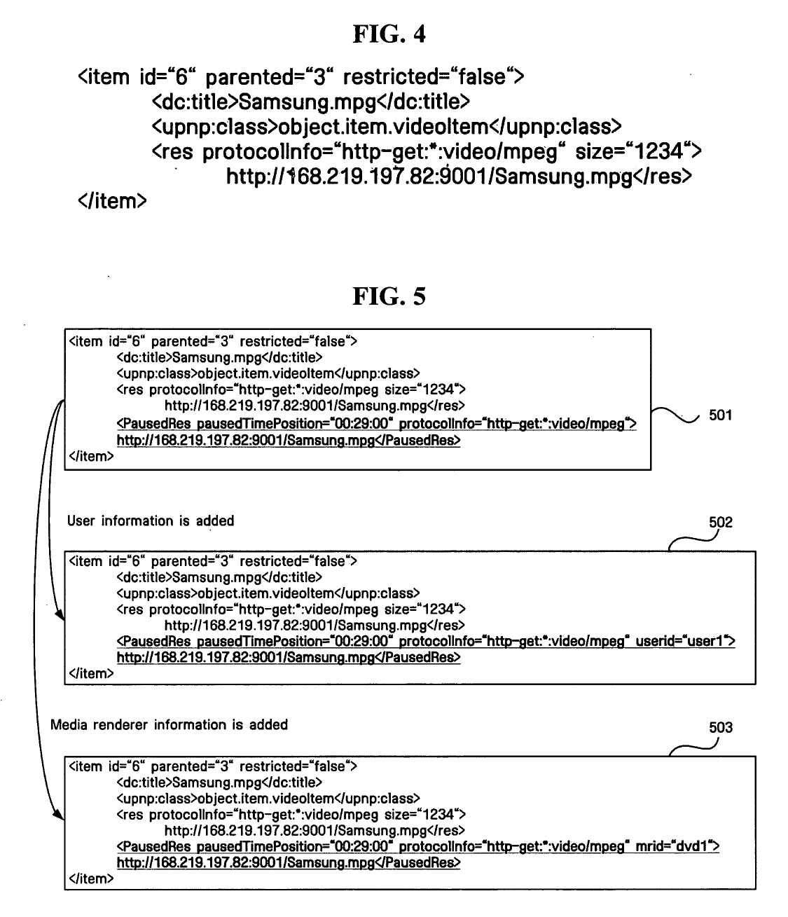

FIG. 4 is a view illustrating an example of the XML document that manages the information on media content in the media server. As described in FIG. 4, the XML document presents content as items. Such information as dc:title, upnp:class and res is set in the items. The dc:title indicates the title of content, and the upnp:class indicates the kind of content. In the meantime, the res provides the URI information on content, along with protocolinfo, which is information on the protocol, and the size of the content.

Thus, the pause time information on the media content can be stored in an item, so that it can be used as reference for the playback of the content or the playback in another media renderer.

FIG. 5 is a diagram illustrating that the pause time information is produced as an item to be stored equally with res according to an exemplary embodiment of the present invention.

From the observation of 501 having information on items of an XML document, it can be seen that URI information can be obtained through the res included in an item containing the information on content. Further, PausedRes is newly itemized to include the pause time information and provide res-set resource information. The pause time information can be set up by pausedTimePosition. In addition, the paused spot of content can be calculated by setting time information on start time and pause time of the media content and then performing a calculation on the basis of the time information.

Therefore, the Media renderer can automatically play back the content from the pause point of time according to the calculated res or PausedRes when the content having an item id of 6 is played back. And, a user is allowed to decide whether the content is played back from the beginning or from the pause point of time. Upon completion of playback, the PausedRes information may be eliminated so the content can be played back from the beginning next time. In FIG. 5, a pausedTimePosition value is ‘00:29:00’, which means that the content were played back for 29 minutes and then paused. Accordingly, the content can be played back from the pause point of time of 29 min.

A plurality of users can use media content through the home network. If a first user stops playback of content 1, and then a second user wants playback of the content 1, information on the user who has stopped the playback can be stored to avoid the content from being played back from the pause time set by the first user. According to 502, among PausedRes items of 501, the item ‘userid’ is added to store identification of the first user when the first user has stopped the playback of the content. Accordingly, when another user (second user) starts playback of the content, the content is supposed to be played back according to res item, not the PausedRes item. But, if the first user wants playback again, the content can be played back according to the PausedRes item.

If there are a plurality of media renderers in a home network, information on the media renderer which has paused the playback can be stored. According to 503, ‘dvd 1’ is set in mrid. Through the mrid value, it can be seen that the media renderer which has paused the playback of the content is dvd1.

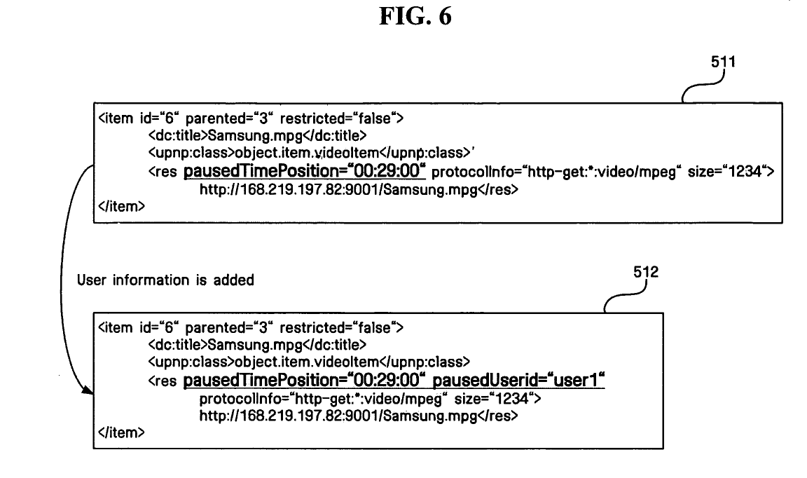

FIG. 6 is a diagram illustrating that pause time information is set in res as an attribute according to another exemplary embodiment of the present invention. According to 511 having information on items of the XML document, the URI information can be obtained from res, an item containing information on content. Unlike in FIG. 5, a new attribute, pausedTimePosition, is established in res to add information on pause time. It is also possible to calculate the pause time spot of the content by setting the information on the start time and the pause time of the media content and then performing the calculation on the basis of the information, as described in FIG. 5. In FIG. 6, pausedTimePosition is ‘00:29:00’, which means that the content has been played back for 29 minutes and paused. So, if a user wants playback again, it is possible to play back the content from the time point of 29 min.

As such, when content whose item id is 6 is played back, the media renderer can automatically play back the content according to pausedTimePosition value of res. In addition, the user can decide whether playback starts from the beginning or from the pause time. Upon completion of the playback, the pausedTimePosition information is eliminated so that the content can be played back from the beginning next time.

A plurality of users can use media content through the home network. If the first user stops playback of content 1, and then second user wants playback of the content 1, information on the user who has stopped the playback can be stored to avoid the content from being played back from the pause time set by the first user. According to 512, a new attribute, pausedUserid, is established in res items of 511, and when the first user pauses the content, an identification of the first user is stored in the pausedUserid. Therefore, when another user (second user) starts playback of content, it is possible to avoid the content from being played back from the pause time set by the first user. But, when the first user wants playback again, the content can be played back according to PausedRes item. As described in 503 of FIG. 5, the pausedMRid can be established in this exemplary embodiment to store information on the media renderer in which playback of content is paused.

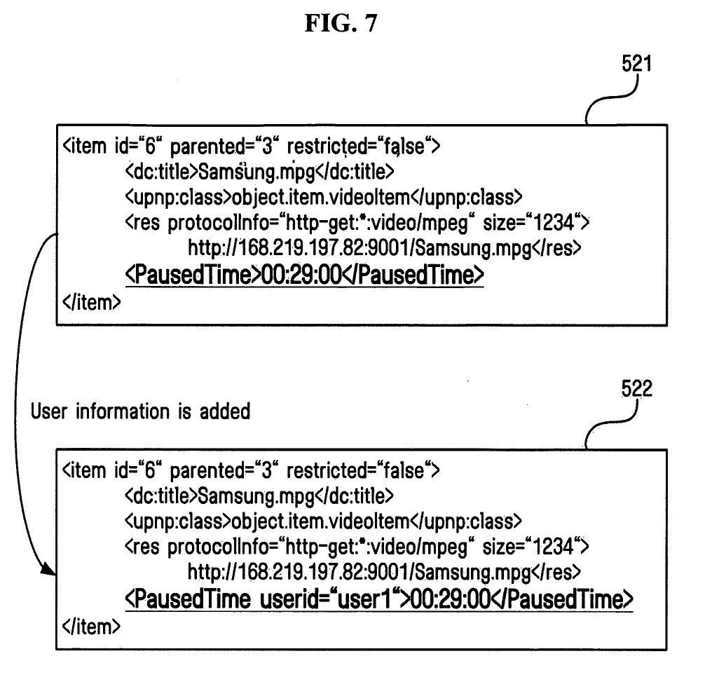

FIG. 7 is a diagram illustrating that the pause time information is established as a new item according to another exemplary embodiment of the present invention.

According to 521 containing information on items of an XML document, among items having information on content, a new item named PausedTime is additionally established, which contains the pause time information. As described in FIG. 5, the information on the start time and the pause time of content is set, and thus the pause time spot of content can be calculated. In FIG. 7, PausedTime value is ‘00:29:00’, which means that the content has been played back for 29 minutes and then paused. Thus, when the content is played back again, the content can be played back from the time point of 29 minutes.

Thus, when the content having the item id of 6 is played back, the media renderer can automatically play back the content according to PausedTime value. In addition, a user can decide whether to play back the content from the beginning or from the pause point of time. Upon completion of playback, the PausedTime item is eliminated so that next playback of the content starts from the beginning.

A plurality of users can use the media content through the home network. If the first user stops playback of content 1 and a second user wants playback of the content 1, information on the user who has stopped the playback can be stored to avoid the content from being played back from the pause time set by the first user. According to 522, a new attribute, userid, is established in PausedTime of 521. Accordingly, when the first user pauses content, the id of the first user is stored. Accordingly, when another user (second user) starts playback of the content, it is possible to avoid the content from being played back from the pause time set by the first user. However, when the first user wants playback again, the content can be played back according to the PausedTime item. As described in 503 of FIG. 5, pausedMRid is established as an attribute in PausedTime items to store information on the media renderer in which playback of content is paused.

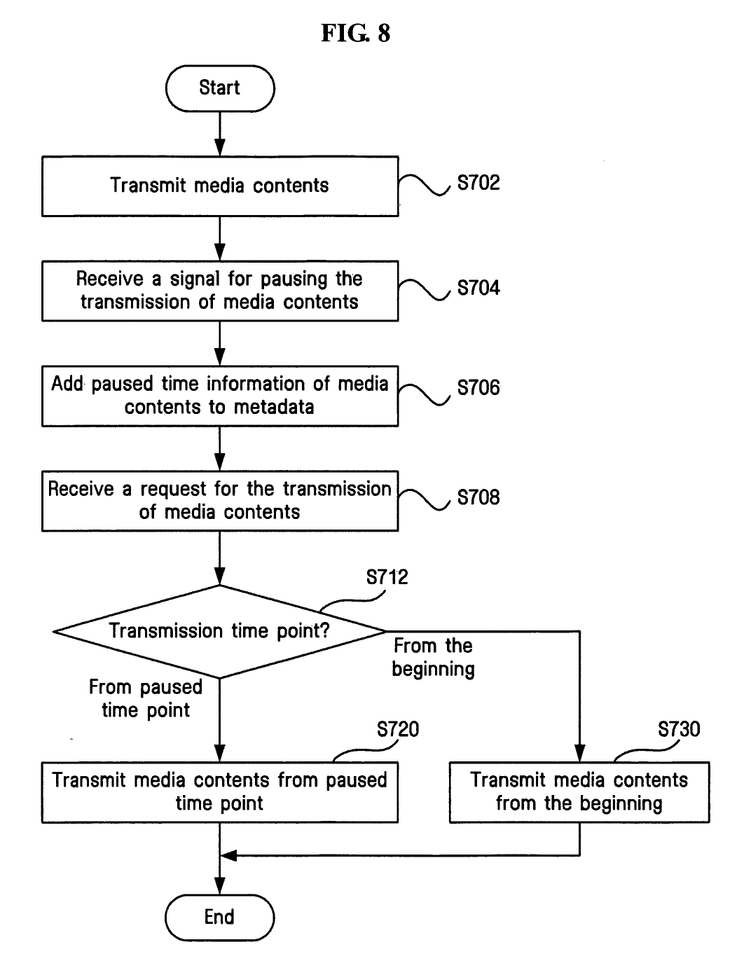

FIG. 8 is a flow chart illustrating the processes of storing the pause time information on media content in the metadata in a media server according to an exemplary embodiment of the present invention. When the media server receives a request for media content from the media renderer, the media server transmits the content to the media renderer S702. If a signal for causing the playback of the media content to pause is sent to the media renderer during the transmission of media content by the media server, the media renderer may be disconnected from the media server. Or, the media renderer may transmit a signal, which notifies the media server that the transmission of the media content should be stopped, to the media server S704. At this time, the media server adds pause time information on media content to metadata S706. The method to add the information has been described with reference to FIGS. 5 to 7. Then, the media server is again requested for transmission of the media content S708. The above processes occur when the media content are once paused in the media renderer and later played back in the same media renderer or in another media renderer. Metadata keeps the pause time information by the method described in FIGS. 5 to 7. The media server decides whether to start the playback of the content again from the pause point of time or from the beginning S712. If the media server keeps pause time information or the same user who has paused the playback wants the playback of the same content again, the media server transmits the media content from the pause point of time S720. On the other hand, if there is no pause time information or another user wants playback of the media content, the media server transmits the content from the beginning S730.

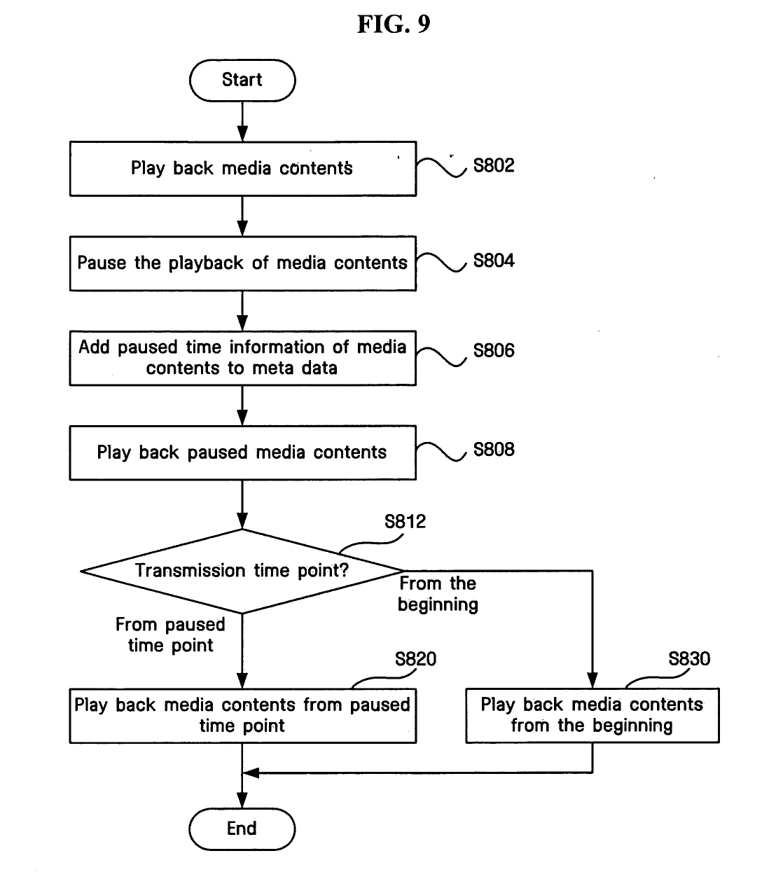

FIG. 9 is a flow chart illustrating processes of changing the pause time information in the media server by means of the control point using UpdateObject according to another exemplary embodiment of the present invention. The control point receives information on media content from the media server and then requests the media renderer to play back the media content S802. The control point requests the media renderer to pause the content being played back S804. Then, the control point adds the pause time information on media content to metadata S806. These processes can be completed by using UpdateObject, as described herein. The method to add pause time information has been described in detail with reference to FIGS. 5 to 7. If a user moves to another place or wants to play back the media content again through the same media renderer after a predetermined period of time has passed, a playback point depends on the pause time information.

A media renderer requests the media server, through the control point, to send the media content, which occurs when media content are once paused in media renderer and later played back in the same media renderer or in another media renderer. At this time, the pause time information is stored in the metadata of media content in the same method as those described in FIGS. 5 to 7. Therefore, the media server decides whether to play back the content from the pause point of time or from the beginning S812. If the pause time information is stored or the same user who has paused the playback of the media content wants to play back the content again later, the media server transmits the media content from the pause point of time, and accordingly, the media content is played back from the pause point of time S820. In the meantime, if there is no stored pause time information or another user wants the playback later, the media server transmits the media content from the beginning, and accordingly, the media content is played back from the beginning S830.

According to aspects of the exemplary embodiments of the present invention, when media content is played back in many apparatuses under the UPnP environment, the apparatuses can share the pause time information.

Further, according another aspect of the exemplary embodiments of the present invention, the media content can be played back continuously in different locations or at different times by using the pause time information on media content.

The effects of the present invention are not limited to the exemplary embodiments set forth herein. It should be understood that other effects of the present invention not described hereinbefore will be defined by the appended claims.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are riot limitative but illustrative in all aspects. In addition, the scope of the present invention is defined by the appended claims rather than by the above exemplary embodiments, and all changes that fall within meets and bounds of the claims, or equivalence of such meets and bounds are therefore intended to be embraced by the claims.

What is claimed is:

1. A method of using pause time information on media content under a UPnP environment, comprising:
transmitting the media content to a first media renderer;
receiving a signal that stops the media content from being transmitted;
stopping transmitting the media content and adding the pause time information on the media content to the media content or metadata that stores information on the media content; and
retransmitting the media content based on the pause time information if the first media renderer or a second media renderer requests transmission of the media content.

2. The method of claim 1, further comprising:
adding information on a first user, who requested a transmission of the media content through the first media renderer, to the media content or metadata,
wherein, in the retransmitting of the media content, if a second user that requests transmission of the media content is the same as the first user, the media content is transmitted from a pause point of time.

3. The method of claim 1,
wherein the stopping of the transmission of the media content and the adding of the pause time information on the media content includes:
correcting the metadata with respect to the media content by means of a content directory service “CDS”.

4. The method of claim 1,
wherein the adding of the pause time information to the media content is adding the pause time information to an XML document that stores URI information on the media content.

5. The method of claim 4,
wherein, in the adding of the pause time information, a new information including resource information and the pause time information is added within an item including information on the media content.

6. The method of claim 4,
wherein, in the adding of the pause time information, the pause time information is added as attribute information in a ‘res’ region within an item including information on the media content, the ‘res’ region including resource information.

7. The method of claim 4,
wherein, in the adding of the pause time information, a new item including the pause time information is added within an item including information on the media content.

8. The method of claim 1, further comprising:
receiving a decision result on whether the media content is to be transmitted from a pause point of time or from another point of time, before the retransmitting of the media content.

9. A method of using pause time information on media content under a UPnP environment, comprising:
playing back the media content;
stopping playing back of the media content;
adding the pause time information on the media content to the media content or metadata that stores information on the media content; and
resuming playing back the media content based on the pause time information when the media content needs to be played back again.

10. The method of claim 9, further comprising:
adding information on a first user, who has played back the media content, to the metadata,
wherein, in the resuming playing back of the media content, if a second user that requests playback of the media content is the same as the first user, the media content is played back from a pause point of time.

11. The method of claim 9,
wherein the adding of the pause time information on the media content includes:
revising the metadata by use of a control point separate from a media renderer for playing back the media content.

12. The method of claim 9,
wherein the adding of the pause time information on the media content is adding the pause time information to an XML document that stores URI information on the media content.

13. The method of claim 12,
wherein, in the adding of the pause time information, a new information including resource information and the pause time information on the media content is added within an item including information on the media content.

14. The method of claim 12,
wherein, in the adding of the pause time information, the pause time information is added as attribute information in a “res” region within an item including information on the media content, the “res” region including resource information.

15. The method of claim 12,
wherein, in the adding of the pause time information, a new information including the pause time information on the media content is added within an item including information on the media content.

16. The method of claim 9, further comprising:
receiving a decision result on whether the media content is to be played back from a pause point of time or from another point of time, before the resuming playing back of the media content.

17. An apparatus for playing media content, comprising:
a media server that stores the media content;
a first media renderer that plays back the media content and is configured to store pause information in the media content or metadata related to the media content; and
a control point that provides input to the first media renderer and the media server from a first user,
wherein if the first user requests that the media content be played, the control point sends a play input to the media renderer and the media server transmits the media content to the media renderer,
wherein if the first user requests that the media content be paused, the control point transmits a pause input and the media server records pause information on the media content or metadata related to the media content.

18. The apparatus for playing media content according to claim 17, wherein the control point transmits the pause input to the media renderer that transmits the pause input to the media server.

19. The apparatus for playing media content according to claim 17, wherein the control point transmits the pause input directly to the media server.

20. The apparatus for playing media content according to claim 17, wherein the pause information is recorded in at least one of an XML document, the metadata, and the media content.
